(19) United States
(12) Patent Application Publication
(10) Pub. No.: US 2006/0154030 A1
(43) Pub. Date: Jul. 13, 2006

(54) Film for packaging purposes, having a partially applied security feature

(76) Inventors: Friedrich Kastner, Grieskirchen (AT); Johann Hilburger, Pirk (DE)

Correspondence Address: WENDEROTH, LIND & PONACK, L.L.P., 2033 K STREET N. W., SUITE 800, WASHINGTON, DC, 20006-1021, US

(21) Appl. No.: 10/534,454

(22) PCT Filed: Nov. 26, 2003
(86) PCT No.: PCT/EP03/13304

§ 371 Date: Dec. 13, 2005

(30) Foreign Application Priority Data
Nov. 28, 2002 (AT) AT 1779/2002

(51) Int. Cl. B44C 1/17

(52) U.S. Cl. 428/195.1

(57) ABSTRACT

The invention relates to films for packaging purposes, particularly even blister films, which have a partially applied security feature. The application of the security features ensues by detaching the security feature from a supporting substrate, which is provided with a UV-curable separating paint that is capable of being deep-drawn.

The invention relates to films, in particular also blister films, for packaging purposes, comprising a regionally applied security feature.

Packaging films with security features are employed in the food, feed or pharmaceutical or cosmetics industry, as packaging means in the construction industry, in the chemical industry, for cleaning agents, for requirements in the gardening and agricultural field, such as soil, fertilizer, mulch or agricultural chemicals and also in the electronics industry for packaging highly sensitive components. In general blister films are primarily utilized for pharmaceutical products. To ensure security against counterfeiting, packaging films, in particular blister films, are provided with a security feature.

For this purpose a transfer lacquer is transferred over the entire surface of a film. Especially if the film is only regionally provided with security features, the necessity of having to apply the finishing and application over the entire surface results in high operating expenses.

It is also known to provide packaging films with structures utilizing a heat stamping process. However, structures produced in a thermal process of this type are exposed to thermal loading during the packaging or sealing process with the consequence of changes occurring in the stamped structure.

The invention therefore addresses the problem of providing a packaging film, in particular a blister film, with regionally applied security features, in particular stable surface structures.

Subject matter of the invention is therefore a packaging film, in particular a blister film, with security features, characterized in that the packaging film, in particular the blister film, comprises in defined regions one or several security features applied thereon, the application of the security features taking place by detaching the security feature from a carrier substrate provided with a UV-curable deep-drawable separation lacquer.

For the production of a security feature which subsequently is applied onto the film, first, onto a web-form substrate a separation lacquer, preferably a UV-curable deep-drawable separation lacquer, is applied. Subsequently, for example, a surface structure can be produced by impressing a mold into this lacquer, which, at the time of the molding, is precured to the gel point, whereupon the radiation-curable lacquer is subsequently cured completely after the surface structure has been formed.

By utilizing the UV-curable deep-drawable lacquer, the layers applied thereon, also an optionally introduced surface structure, are stable after the curing even under thermal loading.

The radiation curable lacquer can be, for example, a radiation curable lacquer system based on a polyester, an epoxy or polyurethane system, which includes two or more different photoinitiators familiar to the person of skill in the arts, which at different wavelengths can initiate the curing of the lacquer system to different extents. For example, one photoinitiator can be activatable at a wavelength of 200 to 400 nm, the second photoinitiator at a wavelength of 370 to 600 nm. A sufficient interval should be maintained between the activation wavelengths of the two photoinitiators so that the second photoinitiator is not too strongly excited while the first photoinitiator is being activated. The range in which the second photoinitiator is excited should be within the transmission wavelength range of the utilized carrier substrate. For the main curing (activation of the second photoinitiator) electron emissions can also be utilized.

As the radiation-curable lacquer can also be utilized a water-dilutable lacquer. Preferred are polyester-based lacquer systems.

The radiation-curable lacquer is stable up to a temperature of 250° C.

This layer is subsequently imprinted with features in the form of lines, symbols, geometric figures, patterns, letters or grids. However, the imprint can also cover the entire surface and/or several different features can be applied in different layers, with the application taking place with register precision with respect to one and/or several layers already present on the carrier substrate. However, the imprint can also completely and/or partially overlap one and/or several layers already present.

The substrate imprinted in this manner is subsequently provided with an adhesive layer, for example a thermally activatable adhesive layer, a self-adhesive layer and can then be cut into filaments, strips, bands or other formats, such as patches and the like.

The cut-to-size security feature is subsequently applied or transferred, respectively, in an application machine, for example a laminating unit, which via web guide elements in front of the infeed introduces the cut security features into the lamination gap or transfer gap or sealing gap, respectively. However, the application is also possible utilizing a stamping press.

The application of the cut security feature can take place with register precision, wherein preferably the packaging film is provided with registration marks and control lines and via a preceding measuring device, for example sensors, is measured longitudinally between two or more registration marks and between two or more actuated tensioning assemblies is adjusted to the requisite register length. Under the control of a control circuit, in particular a register regulator, the material web is subsequently inserted under register control via a register roller ahead of the first printing unit. The page register is driven forward via a web control and inserted via a pivoting frame whereupon the security feature is connected with the packaging film with gauge-pin and register control. The packaging film can optionally be stretched between tensioning assemblies or, for example, be shrunk to the desired length by heating it with a convection drier or IR radiator.

The security feature is preferably applied onto the packaging film or blister film via a temperature-controlled roller or a plate, which may or may not be structured, and therein the web-form carrier substrate is removed. The cut security elements can further also be applied in conventional printing installations, such as for example in flexographic or gravure printing installations with corresponding web guiding elements.

The packaging film provided in this way with one or several security features in defined regions can optionally subsequently be further imprinted.

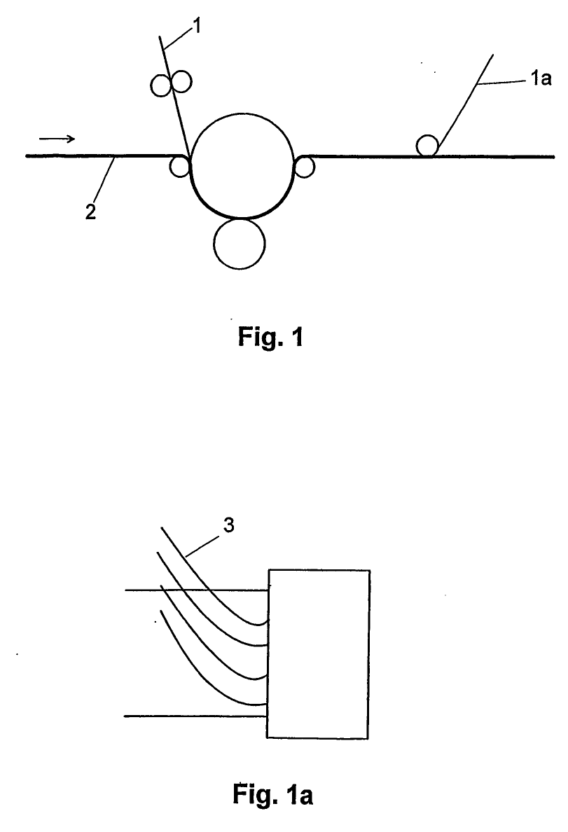

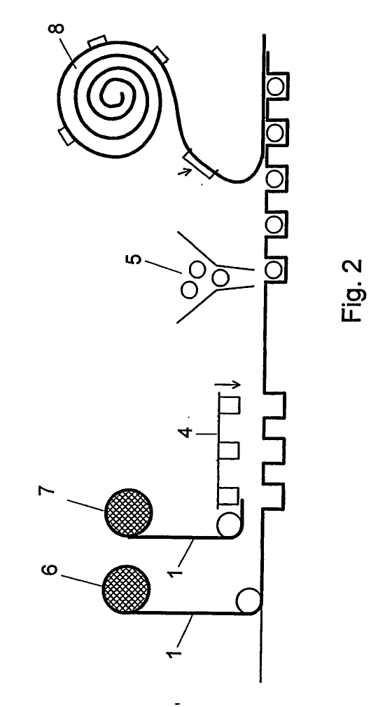

FIGS. 1 and 2 depict the method for the application of the security feature.

FIG. 1 shows the step of application, FIG. 1a a corresponding web feed facility. FIG. 2 shows different application feasibilities in a method for the production of a blister film.

Therein indicate 1 a security feature, 1a a carrier film, 2 a packaging film, 3 a web guiding element, 4 a stamping press, 5 a filling facility, 6, 7 and 8 alternative feeding feasibilities for the security element.

After the application onto the film, it is also possible, due to the high temperature stability of the overall system, to shape it, for example into the form of a bowl, by deep drawing.

Depending on its utilization, the packaging film may also be imprinted before the cut security feature is applied. However, sufficient temperature stability of the printing inks employed must be ensured if the application of the security feature takes place at increased temperatures.

Web-form substrates to be taken into consideration are for example carrier films, preferably flexible synthetic films, comprised for example of PI, PP, MOPP, PE, PPS, PEEK, PEK, PEI, PSU, PAEK, LCP, PEN, PBT, PET, PA, PC, COC, POM, ABS and PVC. The carrier film has preferably a thickness of 5-700 μm, preferred is a thickness of 8-200 μm, and especially preferred is a thickness of 12-50 μm.

As web-form substrates can further be utilized paper webs with smooth surfaces, for example coated, cast coated or varnished paper.

Security features to be considered are visually detectable and/or machine-readable features.

The application of the layers can be carried out utilizing any method, for example through gravure printing, flexographic printing, screen printing, digital printing and the like. The individual features can be applied over the entire surface or regionally, for example in the form of patterns, lines, letters, symbols, geometric shapes, grids and the like.

To apply a feature with optical properties, pigmented or nonpigmented ink or lacquer compositions can be utilized. As pigments can be considered all known pigments, for example pigments on an inorganic basis such as titanium dioxide, zinc sulfide, kaolin, ITO, ATO, FFO, aluminum, chromium and silicon oxides, or organic-based pigments such as phthalocyanine blue, i-indolidine yellow, dioxazine violet and the like, as well as also colored and/or encapsulated pigments in chemically, physically or reactively drying binding agent systems. Coloring substances to be considered are, for example, 1,1- or 1,2-chromium-cobalt complexes. Solvent-containing ink and/or lacquer systems, aqueous and also solvent-free lacquer systems are utilizable therein. As binding agent can be used various natural or synthetic binding agents.

Furthermore, inks or lacquers with luminescent, for example phosphorescent or fluorescent, properties, lacquers having a defined index of refraction or thermochromic inks can be applied.

To apply a feature with magnetic properties, paramagnetic, diamagnetic and also ferromagnetic substances, such as iron, nickel and cobalt or their compounds or salts (for example oxides or sulfides) or alloys of rare earth metals, such as for example cobalt/samarium alloys can be utilized.

Especially suitable are magnetic pigment inks with pigments based on Fe oxides, iron, nickel, cobalt and their alloys, barium or cobalt ferrite, hard and soft magnetic iron and steel types in aqueous or solvent-containing dispersions. Solvents to be considered are, for example, i-propanol, ethyl acetate, methylethyl ketone, methoxy propanol and mixtures thereof.

The pigments are preferably introduced into acrylate polymer dispersions with a molecular weight of 150,000 to 300,000, into acrylate urethane dispersions, acrylate styrene, nitrocellulose or PVC-containing dispersions or into solvent-containing dispersions of this type.

The magnetic layer can, for example, also be applied regionally in the form of a code, for example in the form of a so-called bar code, which, in this case, can optionally be machine-readable.

To apply a layer having electric properties, to the ink or the lacquer to be applied can be added for example graphite, carbon black, conductive organic or inorganic polymers, metal pigments (for example copper, aluminum, silver, gold, iron, chromium and the like), metal alloys such as copper-zinc or copper-aluminum or also amorphous or crystalline ceramic pigments such as ITO, ATO, FFO and the like. Further, doped or non-doped semiconductors, such as for example silicon, germanium or doped or non-doped polymer semiconductors or ion conductors, such as amorphous or crystalline metal oxides or metal sulfides, can be employed as additives. Further, for setting the electric properties, to the layer can be added polar or partially polar compounds, such as tensides or nonpolar compounds such as silicon additives or hygroscopic or non-hygroscopic salts can be utilized or added to the lacquer. Transistors can optionally also be generated on the conducting paths utilizing printing techniques.

As layers with electric properties, a regional metal layer can also be applied, the regional application being carried out by means of an etching process (application of a metal layer over the entire surface and subsequent regional removal by etching) or by means of a demetaluization process.

When utilizing a demetallization process a solvent-soluble ink (optionally in the form of an inverse coding) is applied in a first step, subsequently, optionally after activation of the carrier substrate through a plasma or corona treatment, the metallic layer is applied, whereupon the soluble ink layer, together with the metallization present in these regions, is removed through treatment with a suitable solvent.

An electrically conductive polymer layer can further also be applied as the electrically conductive layer. The electrically conductive polymers can be, for example, polyaniline or polyethylene dioxythiophene.

Such a layer can also function as an antenna, where on the antenna structure contact areas for connecting one or several microcircuits can be provided.

In the event additional information is to be stored, the antenna structure can serve as a direct contact area for conventional chip systems, conventional electronic circuits and the like.

Furthermore, printed electronic circuits can also be comprised of electrically conductive polymers and/or vapor-deposited metallic layers and/or semiconductors in connection with conductive polymers.

Such structures are especially suitable if the one blister film is to be used for so-called pill timers in the field of pharmaceuticals.

As security features are also to be considered additional surface contour structures, for example diffraction gratings, holograms and the like, and these structures can optionally also be metallized or partially metallized.

Furthermore can also be applied security features, which exhibit different color effects (chromatic tilt effect) when viewed at different viewing angles. These features are in this case comprised of at least one layer reflecting electromagnetic waves, a spacer layer and a layer formed of metal clusters.

Preferably a regional or all-over layer reflecting electromagnetic waves is initially applied and subsequently one or several polymeric layers of defined thickness are applied regionally and/or over the entire surface. Subsequently onto the spacer layer is applied a layer formed of metal clusters, which is produced by means of a process utilizing vacuum technology or from solvent-based systems.

So-called biomarkers in the form of DNA codings can optionally also be applied.

In the manner according to the invention packaging films provided with security features in defined areas can be utilized especially advantageously for packaging purposes in which high counterfeiting security is desired. The packaging films according to the invention are in particular employed in the electronics industry, for data media, for packaging food items or feed items or as blister films in the pharmaceutical field for packaging medications, such as pills, dragees, tablets, suppositories, loose powder preparations, granulates, for strip packs, infusion bottle and ampule closures and the like.

1. Packaging films with regionally applied security features, wherein the packaging film has in defined areas one or several security features applied thereon, the application of the security features taking place with the detachment of the security feature from a carrier substrate provided with a UV-curable deep-drawable separation lacquer.

2. Packaging films as claimed in claim 1, wherein the security feature(s) includes (include) a surface structure stamped into the UV-curable deep-drawable separation lacquer.

3. Packaging films as claimed in claim 2, wherein the stamped surface structure is metallized or partially metallized.

4. Packaging films as claimed in claim 1, wherein the security feature(s) includes (include) one or several layers with optical and/or electrical and/or magnetic properties.

5. Packaging films as claimed in claim 4, wherein the security element(s) includes (include) one or several layers with luminescent and/or thermochromic properties.

6. Packaging films as claimed in claim 1, wherein the security feature(s) includes (include) one or several layer(s) with chromatic tilt effect and/or biomarkers.

7. Packaging films as claimed in claim 1, wherein the security features include one or several layers, which, independently of other functional properties, have all-over or regionally the form of patterns, lines, letters, symbols, geometric shapes and the like.

8. Packaging films as claimed in claim 1, wherein the security element furthermore includes an adhesion coating.

9. Packaging films as claimed in that claim 1, wherein the packaging film is a blister film.

10. Packaging films as claimed in claim 1, wherein the packaging film is a cold-formable film.

11. Packaging films as claimed in claim 1, wherein the packaging film is a film for strip packs.

12. Method for the production of security features for the application onto a packaging film, wherein onto a carrier substrate is applied a UV-curable deep-drawable separation lacquer, which, subsequently, is optionally provided with further functional layers.

13. Method as claimed in claim 12, wherein onto a carrier substrate is applied a UV-curable deep-drawable separation lacquer, which subsequently is provided with a surface structure by impressing a mold into the lacquer, which, at the time of the molding, is precured to the gel point, whereupon the lacquer is cured completely.

14. Method as claimed in claim 12, wherein subsequently under register control further functional layers and/or an adhesion coating are applied.

15. Method as claimed in claim 12, wherein the security features are subsequently cut to size.

16. Method for the application of regional security features onto a packaging film, wherein the cut-to-size security feature is introduced into the laminating gap of a laminating unit via web guiding elements ahead of the infeed, and is bonded with the packaging film.

17. Method as claimed in claim 16, wherein the cut-to-size security feature is introduced into the laminating gap via a temperature-controlled roller.

18. Method as claimed in claim 16, wherein the packaging film provided with the security feature is subsequently deformed by deep drawing.

19. Method of providing high counterfeiting security in packaging which comprises employing the packaging films as claimed in claim 1.

20. Method for packaging in the electronics industry, for data media, for packaging of food items or feed items, or as blister films in the field of pharmaceuticals for packaging medications, such as pills, dragees, tablets, suppositories, loose powder preparations, granulates, for strip packs, infusion bottle and ampule closures and the like which comprises employing the packaging film of claim 1 in said packaging.
